(19) United States
(12) Patent Application Publication
(10) Pub. No.: US 2017/0195308 A1
(43) Pub. Date: Jul. 6, 2017

(54) MEDICAL DEVICE CONTROL SYSTEM, AND METHOD FOR OPERATING SAID MEDICAL DEVICE CONTROL SYSTEM

(71) Applicant: TRUMPF MEDIZIN SYSTEME GMBH + CO. KG, Saalfeld (DE)

(72) Inventors: Rudolf MARKA, Ismaning (DE); Serhan ÖZHAN, Munich (DE); Gel HAN, Munich (DE)

(21) Appl. No.: 15/322,322

(22) PCT Filed: Jun. 26, 2015
(86) PCT No.: PCT/EP2015/064538

§ 371 Date: Dec. 27, 2016

(30) Foreign Application Priority Data
Jun. 30, 2014 (DE) 102014212658.4

(51) Int. Cl. H04L 29/06; G06F 21/32; H04W 4/00; G06F 21/36; G06F 19/00; H04L 29/08

(52) U.S. Cl. CPC H04L 63/083; G06F 19/3418; H04L 67/125; H04W 4/008; G06F 21/36; G06F 21/32

(57) ABSTRACT

A medical apparatus control system with a simplified release of an operating function is provided. The medical apparatus control system comprises at least one mobile control unit (3), for at least one medical apparatus (2), having at least one radio receiving module (4) for detecting a forwarding radio signals, a control device (6) connected to the mobile control unit (3), and at least one separate mobile radio transmitting module (5) enabled to communicate with the radio receiving module (4). The at least one radio transmitting module (5) is configured to send an identification features to the radio receiving module (4), and the control device (6) is configured to compare the identification feature with stored identification features and to release an operating function of the mobile control unit (3) after a positive result of comparison.

The invention relates to a medical apparatus control system and a method for operating the medical apparatus control system, in particular to a system and a method enabling a simplified release of an operating function.

Up to now, medical apparatuses have been controlled by control panels attached to medical apparatuses or by a remote control assigned to the medical apparatus. Thereby, an authorization for an operation of the individual medical apparatuses has been clearly delimited.

Recently, mobile control units for the operation of several medical apparatuses are increasingly used. As the case may be, it is however necessary that only specific persons are authorized for the operation of the medical apparatuses.

However, an elaborate login procedure is not possible e.g. in an operating theater during a surgery since an immediate operation of the medical apparatus can be necessary in an emergency situation.

The invention is based on the object to provide a medical apparatus control system enabling a simplified login procedure for operating the medical apparatus control system for predefined users.

The object is achieved by a medical apparatus control system according to claim 1 and a method according to claim 7.

By a medical apparatus control system according to claim 1, it is possible to enable a simple release of an operation of a mobile control system in a personal manner.

The invention is now elucidated by means of embodiments referring to the attached drawings.

In particular:

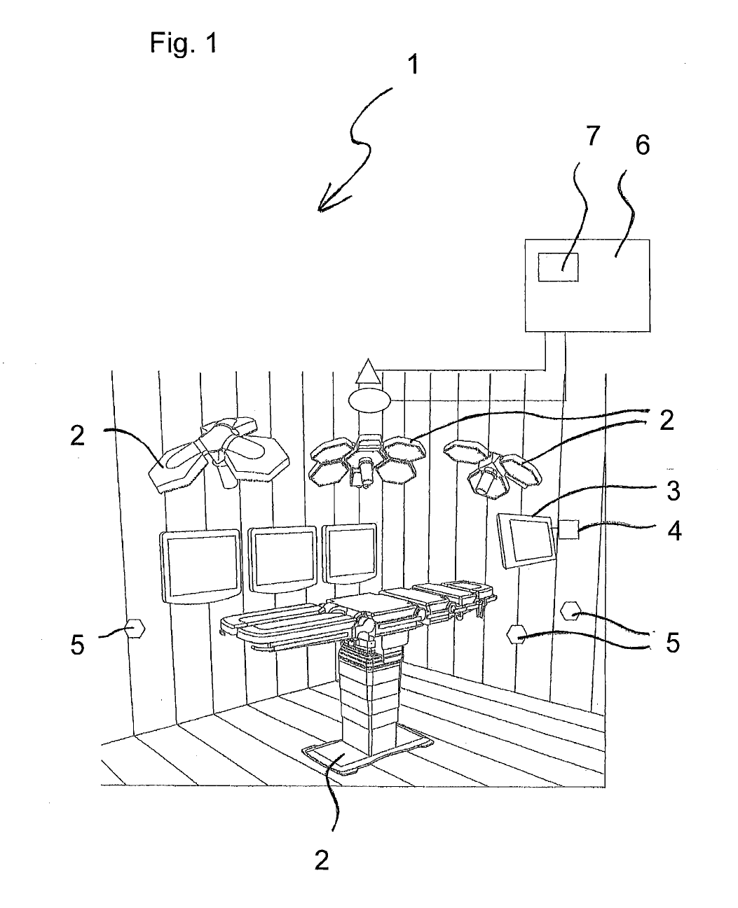

FIG. 1 shows a perspective view of an operating theater; and

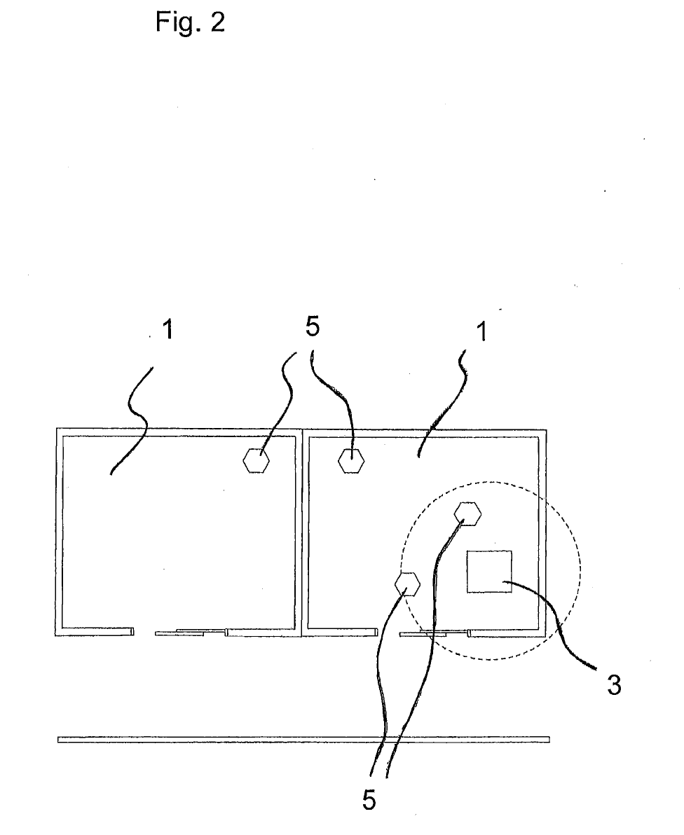

FIG. 2 shows a floor plan of a section of a building having operating theaters.

In FIG. 1, a perspective view of an operating theater as room 1 in a section of a building, e.g. in a hospital, is shown. In the room 1, as medical apparatuses 2, a surgical table and several surgical lamps are illustrated. Furthermore, a tablet PC is provided as a mobile control unit 3 for the medical apparatuses 2. The mobile control unit 3 is equipped with a radio receiving module 4.

Furthermore, separate mobile radio transmitting modules 5 are provided in the room 1. The separate mobile radio transmitting modules 5 are here provided in so-called badges. These badges are here worn by the operating room personal. The radio transmitting modules 5 respectively emit a signal comprising an identification feature corresponding to the individual badges, by which the individual persons of the operating room personal can be identified. As to be seen in FIG. 1, one badge 5 is located at the left side of the figure and two badges 5 directly at the mobile control unit 3.

The signals emitted by the separate mobile radio transmitting modules 5 are received by the radio receiving module 4 of the mobile control unit 3 so that the radio transmitting modules 5 are enabled to communicate with the radio receiving module 4.

Furthermore, a control device 6 connected to the mobile control unit 3 is provided. The control device 6 comprises a memory area 7 in which the identification features of the badges or of the radio transmitting modules 5, as the case may be, with further data, here, optionally with a password or a long-password (described later), are stored.

The control device 6 is configured such that it detects a signal having the identification feature detected by the radio receiving module 4 and forwarded to the control device 6 and compares it with the identification features stored in the memory area 7. After a positive result of the comparison, when matching of the identification features has been noted, the control device 6 is configured to release an operating function of the mobile control unit 3.

Optionally, this release occurs after input of an associated password or long-password.

The radio receiving module 4 is configured such that a signal strength of the radio signal of the radio transmitting module 5 is detected. In the radio receiving module 4, a threshold is defined so that only radio signals, the signal strength of which are above the threshold, are forwarded from the radio receiving module 4 to the control device 6.

These components, the mobile control unit 3, the radio receiving module 4, the radio transmitting module 5, and the control device 6 are constituents of the medical apparatus control system.

In this embodiment, the radio receiving module 4 of the mobile control unit 3 and the radio transmitting module 5 are “Blue-tooth Low Energy” (BLE) modules. In alternative embodiments, these modules are e.g. RFID modules, ZigBee modules or WLAN modules.

In this embodiment, a single mobile control unit 3 and four medical apparatuses 2, namely the surgical table and three surgical lamps, are illustrated. In alternative embodiments, also several mobile control units 3 and/or another quantity of medical apparatuses can be provided.

In FIG. 2, a floor plan of the section of a building having the operating theaters as rooms 1 is shown.

As to be seen in FIG. 1, two badges having the radio transmitting modules 5 are located directly at the mobile control unit 3 and one badge having one of the radio transmitting modules 5 in the opposite corner of the room 1. Therefore, two members of the operating room personal are in direct outrange of the mobile control unit 3. A further badge having one of the radio transmitting modules 5, therefore, a further member of the operating room personal, is in another room 1. Around the mobile control unit 3, an area having a maximum predefined distance where all radio transmitting modules 5 are to be located so that their signal strength is above the threshold is indicated. Thus, their respective prompt is displayed on the mobile control unit 3.

In use, in order to operate the medical apparatus control system, a user has firstly to be logged in. In order to perform the login as quickly as possible, the identification features are used, as the case may be, together with a shortened password.

Thereto, the radio transmitting module 5 of the badges transmits a message with the identification feature of the radio transmitting module 5 in periodical intervals. This identification feature is e.g. a MAC address or a name of the module. The signal is received by the radio receiving module 4 in the mobile control unit 3 and forwarded to the control device 6. The control device 6 compares the identification feature with the identification features stored in the memory area 7 and releases the operating function of the mobile control unit 3 upon a positive result of comparison, therefore, if the detected identification feature matches one of the stored identification features.

Optionally, this release is reversed after a predefined period in which the mobile control unit 3 is not operated.

As soon as the release is reversed after the predefined period or after the user logs out, the signals of the radio transmitting modules 5 are again detected and the vicinity of the mobile control unit is quasi scanned.

In a further option, it is necessary to additionally input a password. Thereto, a prompt corresponding to the identification feature, e.g., a name of a member of the operating room personal, is output on the mobile control unit 3 and the respective password of the appropriate person thereto is input at the mobile control unit 3.

In alternative embodiments, instead of the password, it is also possible to input a graphic pattern or to perform a face or a fingerprint recognition.

If several members of the operating room personal having badges are in the domain of the mobile control unit 3, all of the prompts (names) corresponding to the identification features are optionally output. Then, a member of the operating room personal selects its name and inputs its appropriate password.

To ensure major security, it is optionally necessary to input a so-called long-password upon a first login at the medical apparatus control system. With respect to its security, this password then corresponds to according guidelines and has an appropriate length. As soon as the first login is done, a shorter password can be input to perform a so-called quick-login in combination with the identification feature.

The members of the operating room personal being in the vicinity of the mobile control unit 3 are considered as potential users of the medical apparatus control system. This point of view is implemented in the medical apparatus control system such that the threshold in the radio receiving module 4 is adjusted such that only the respective prompts of radio transmitting modules 5 being located in a predefined distance from the mobile control unit 3 are shown. As a predefined distance, e.g., the outreach of one of the users can be considered.

In a further alternative embodiment, only specific operating functions of the mobile control unit 3 assigned to one identification feature, therefore, to one of the users, are released.

The different embodiments having the individual options can be combined with one another.

What is claimed is:

1. 1-15. (canceled)

16. A medical apparatus control system, comprising
at least one mobile control unit, for at least one medical apparatus, with at least one radio receiving module for detecting and forwarding radio signals,
a control device connected to the mobile control unit, and
at least one separate mobile radio transmitting module enabled to communicate with the radio receiving module,
wherein the at least one radio transmitting module is configured to send an identification feature to the radio receiving module, and
the control device is configured to compare the identification feature with the stored identification features, and to release an operating function of the mobile control unit after a positive result of comparison.

17. The medical apparatus control system of claim 16, wherein the radio receiving module and the radio transmitting module are Bluetooth Low Energy modules.

18. The medical apparatus control system of claim 16, wherein the radio receiving module and the radio transmitting module are ZigBee modules.

19. The medical apparatus control system of claim 16, wherein the radio receiving module and the radio transmitting module are RFID modules.

20. The medical apparatus control system of claim 16, wherein the radio receiving module and the radio transmitting module are WLAN modules.

21. The medical apparatus control system of claim 16, wherein the radio receiving module is adapted such that it detects a signal strength of the radio signal, and that it comprises a threshold for the signal strength, wherein only radio signals, the signal strength of which is above the threshold, are forwarded.

22. A method for operating a medical apparatus control system comprising
at least one radio transmitting module sending a signal having an identification feature,
a radio receiving module receiving the signal and forwarding it to a control device,
a control device comparing the identification feature with stored identification features, and
the control device releasing the operating function of the mobile control unit if the result of comparison is positive.

23. The method of claim 22, wherein the medical apparatus control system reverses the release if the mobile control unit is not operated after a predefined period.

24. The method of claim 23, wherein a respective passcode is stored for the identification feature of each radio transmitting module, and the mobile control unit outputs a prompt corresponding to the identification feature, and releases the operating function of the mobile control unit if the appropriate passcode is additionally input.

25. The method of claim 22, wherein a respective passcode is stored for the identification feature of each radio transmitting module, and the mobile control unit outputs a prompt corresponding to the identification feature, and releases the operating function of the mobile control unit if the appropriate passcode is additionally input.

26. The method of claim 25, wherein the passcode comprises a graphic pattern that is input.

27. The method of claim 25, wherein inputting the passcode comprises performing a face recognition function.

28. The method of claim 25, wherein, if signals having the respective identification features of several radio transmitting modules are received by the radio receiving module, prompts corresponding to the identification features of all of the signals are output on the mobile control unit, and the operating function of the mobile control unit is released if anyone of the prompts is selected and the respective passcode is input.

29. The method of claim 28, wherein upon a first login at the medical apparatus control system, an expanded passcode being more extensive than the established passcode is input, the medical apparatus control system reverses the release after a predefined period in which the mobile control unit is not operated, and the expanded passcode replaces the prior passcode.

30. The method of claim 29, wherein upon a first login at the medical apparatus control system, an expanded passcode being more extensive than the established passcode is input, the medical apparatus control system reverses the release after a predefined period in which the mobile control unit is not operated, and the expanded passcode replaces the prior passcode.

31. The method of claim 30, with a medical apparatus control system, wherein the threshold is adjusted such that only the respective prompts of radio transmitting modules located within a predefined distance from the mobile control unit are shown.

32. The method of claim 31, wherein only an operating function assigned to the identification feature is released.

33. The method of claim 25, with a medical apparatus control system, wherein the threshold is adjusted such that only the respective prompts of radio transmitting modules located within a predefined distance from the mobile control unit are shown.

34. The method of claim 33, wherein only an operating function assigned to the identification feature is released.
